(19) United States
(12) Patent Application Publication
(10) Pub. No.: US 2025/0069173 A1
(43) Pub. Date: Feb. 27, 2025

(54) MEAL MANAGEMENT APPARATUS AND METHOD OF USE THEREOF

(71) Applicant: Rajesh Kumar, Phoenix, AZ (US)

(72) Inventor: Rajesh Kumar, Phoenix, AZ (US)

(21) Appl. No.: 18/800,082

(22) Filed: Aug. 11, 2024

Related U.S. Application Data
(60) Provisional application No. 63/533,966, filed on Aug. 22, 2023.

(51) Int. Cl. G06Q 50/20

(52) U.S. Cl. CPC G06Q 50/205

(57) ABSTRACT

The invention comprises a meal manager system/apparatus using an artificial intelligence system trained to create a USDA compliant school breakfast/lunch menu. Optionally, the meal manager separately and/or additionally assesses actual nutrient delivered to the students by assessing, with an intelligent system, waste left on a student tray at time of disposal.

### CROSS-REFERENCES TO RELATED APPLICATIONS

This application claims the benefit of U.S. provisional patent application No. 63/533,966, filed Aug. 22, 2023, all of which is incorporated herein in its entirety by this reference thereto.

### BACKGROUND OF THE INVENTION

### Field of the Invention

The invention relates generally to a meal management system.

### Discussion of the Prior Art

### Problem

There exists in the art a need for a meal management system that is at least semi-automated.

### SUMMARY OF THE INVENTION

The invention comprises a meal management apparatus and method of use thereof.

### DESCRIPTION OF THE FIGURES

A more complete understanding of the present invention is derived by referring to the detailed description and claims when considered in connection with the Figures, wherein like reference numbers refer to similar items throughout the Figures.

FIG. 1 illustrates a meal manager system;

FIG. 2 illustrates USDA regulations;

FIG. 3 illustrates school preferences;

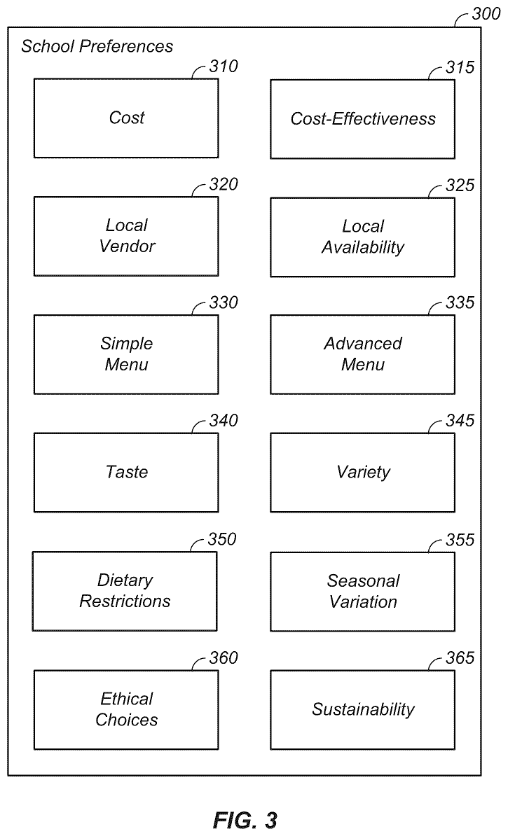

FIG. 4 illustrates pricing;

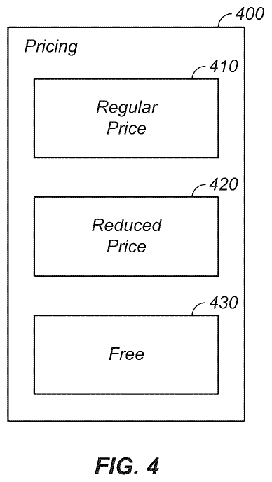

FIG. 5 illustrates recipe databases;

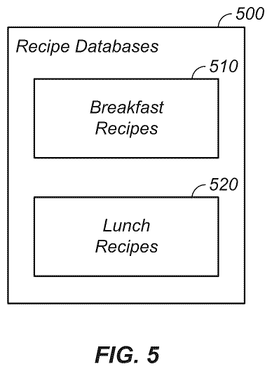

FIG. 6 illustrates a meal manager;

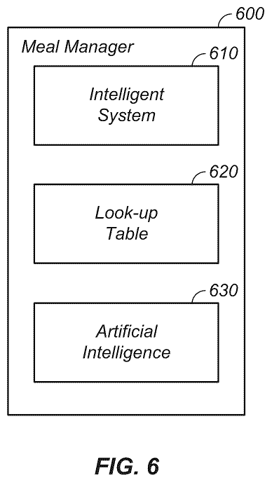

FIG. 7 illustrates USDA compliant menus;

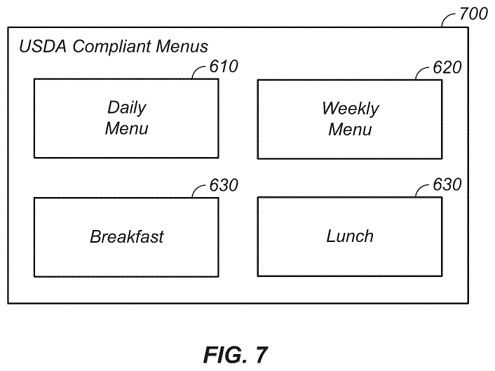

FIG. 8 illustrates a feedback system;

FIG. 9 illustrates a meal analysis system;

FIG. 10 illustrates an actual nutrition system; and

FIG. 11 illustrates a camera monitoring system.

Elements and steps in the figures are illustrated for simplicity and clarity and have not necessarily been rendered according to any particular sequence. For example, steps that are performed concurrently or in different order are illustrated in the figures to help improve understanding of embodiments of the present invention.

### DETAILED DESCRIPTION OF THE INVENTION

The invention comprises a meal manager system/apparatus using an artificial intelligence system trained to create a USDA compliant school breakfast/lunch/dinner menu. Optionally, the meal manager separately and/or additionally assesses actual nutrient delivered to the students by assessing, with an intelligent system, waste left on a student tray at time of disposal.

Herein, an intelligent system/artificial intelligence is used to prepare USDA compliant menus, such as school lunch menus.

Herein, for clarity of presentation and without loss of generality, school lunch also refers to school breakfast, school dinner, and/or school snacks (smart snacks).

### Meal Planning

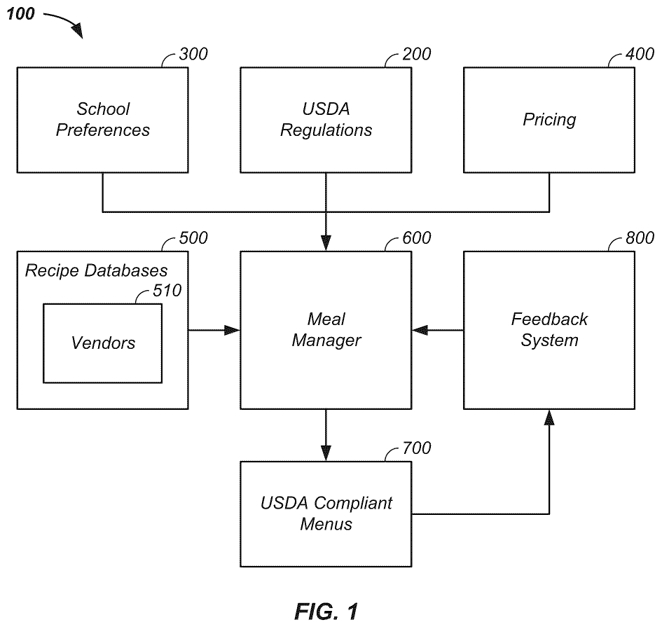

Referring now to FIG. 1, a computer implemented method and/or device 100 is used to plan menus, such as a USDA compliant school lunch menu. Generally, any one or more of United States Department of Agriculture (USDA) regulations 200 or USDA rules, school preferences 300, pricing 400, and recipe databases 500 are provided to a meal manager 600 or main controller, which generates USDA compliant menus 700. Optionally and preferably, future examples/versions of the USDA compliant menus 700 are generated with any of the above parameters in combination with output from a feedback system 1000. Each of the inputs to the meal manager 600 and operation of the meal manager 600 are further described, infra.

### USDA Regulations

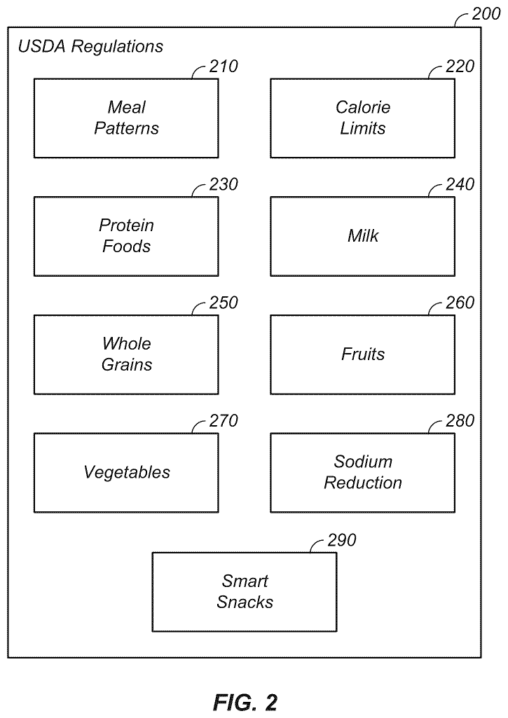

Referring now to FIG. 2, the USDA regulations 200, which are also referred to as USDA rules, are further described. Generally, the USDA regulations 200 for school lunch menus are implemented through the National School Lunch Program (NSLP) and the School Breakfast Program (SBP), which are designed to improve the nutritional quality of meals served to students in participating schools. More particularly, the USDA regulations 200 generally include regulations and/or guidance for meal patterns 210, calorie limits 220, protein foods 230, milk 240, whole grains 250, fruits 260, vegetables 270, sodium reduction 280, and smart snacks 290, which are each further described herein.

Herein, meal patterns 210 refer to established USDA requirements for the types and quantities of food groups that must be offered in school lunches and breakfasts. The meal patterns 210 aim to provide a balanced and nutritious meal for students, which typically include protein foods 230, dairy or milk 240, grains or whole grains 250, and fruits 260, and vegetables 270. For NSLP lunches, schools were required to offer five components: protein foods 230, milk 240, grains 250, fruits 260, and vegetables 270. For SBP breakfasts, schools were required to offer four components: milk 240, grains 250, fruit 260, and either a protein 230, such as a meat/meat alternative or another fruit 260/vegetable 270.

The USDA calorie limits 220 are set to ensure that students receive enough energy while still maintaining a balance to prevent excessive calorie intake. The calorie limits for school lunches vary depending on grade level of the students. Particularly, for grades K-5, the daily calorie range is approximately 550-650 calories, which increases to 600-700 calories for grades 6-8, and to 750-850 calories for grades 9-12. Specific factors, such as age, gender, and/or activity levels can vary the calorie ranges.

The required protein foods 230 were designed to ensure that students receive adequate protein nutrition to support their growth and development. The protein foods 230 provide protein from a variety of sources including: meat, poultry, fish, eggs, legumes, and nuts. More particularly, for grades K-5, protein is to be 8-10 grams of protein per meal, which increases to 9-10 grams for grades 6-8, and 10-12 grams for grades 9-12. Again, specific factors, such as age, gender, and/or activity levels can vary the protein ranges.

The milk 240 requirements were designed to ensure that students receive the necessary nutrients from dairy products while also providing options for those with dietary restrictions. More particularly, low-fat or fat-free milk is required, to encourage healthier beverage choices. Still more particularly, schools are required to offer students a variety of milk choices, including fat-free (skim), low-fat (1%), and unflavored or flavored milk. Flavored milk is allowed to be offered, but it must be fat-free. In addition to dairy milk, schools are allowed to offer non-dairy milk alternatives for students who cannot consume dairy due to dietary restrictions or allergies. Non-dairy milk alternatives, such as soy milk, almond milk, and oat milk, must meet specific nutritional requirements outlined by the USDA. All milk options, whether dairy or non-dairy, must meet certain nutritional standards in terms of calories, protein, vitamins, and minerals. Schools should accommodate students with lactose intolerance or other dietary restrictions, such as religious restrictions, by providing suitable milk alternatives.

The grain/whole grain 250 requirements required whole-grain-rich foods to be served, such as whole grain bread, pasta, and rice, to increase the intake of fiber and essential nutrients. At least half of the grains offered have to be whole grain-rich, by weight. These requirements were put in place to promote healthier eating habits among students by increasing the consumption of whole grains. School meals are required to include a specific amount of fruits as part of the meal offerings. Like other requirements, the exact quantity of fruit required varies based on the grade level of the students. Schools are encouraged to provide a variety of fruits to students, such as fresh, canned, and dried fruits in different forms, such as whole, sliced, diced, or in a fruit salad. The goal is to make the option appealing to students.

The vegetables 270 guidelines were designed to ensure that students have access to a variety of vegetables to support their nutritional needs. Generally, school meals are required to include a specific amount of vegetables as part of the meal offerings, which again varies by grade level. The USDA classifies vegetables into several subgroups based on their nutritional content. These subgroups include dark green, red and orange, legumes (beans and peas), starchy, and other vegetables, which are optionally fresh, cooked, and/or in salads. The vegetables offered in school meals should contribute to the overall nutritional quality of the meal in terms of vitamins, minerals, and dietary fiber.

The sodium reduction 280 is a guideline, not a regulation. Generally, sodium reduction targets are gradually tightened over a period of years.

The smart snacks 290 standards are designed to encourage healthier eating habits among students by promoting the availability of nutritious snacks and beverages in schools. Generally, the standards apply to snacks and beverages sold in vending machines, school stores, and a la carte lines and are largely intended to mimic the calories, fats, sugars, nutrition, and sodium regulations and goals described herein.

Generally, specific factors, such as age, gender, and/or activity levels can vary any of the ranges provided herein by greater than 10, 20, or 30 percent and/or less than 100 percent.

### School Preferences

Referring now to FIG. 2, the school preferences 300 are further described. Generally, the school preferences 300 follow the USDA regulations 200 and set additional parameters, such as set by a state, school district/school union, or school—all of which are referred to herein generically as the school. For example, cost 310 to meet the USDA regulations 200 is now two to three dollars a meal. The cost 310 is optionally set by the school to be a higher amount, such as a fixed amount, such as 3, 4, 5 dollars or more or a percentage, such as greater than 10, 25, 50, or 100% more than the federal amount of, currently, three dollars. The cost-effectiveness 315 is an additional school parameter where any of the above parameters, such as nutritional value, are valued above other parameters, such as taste. The local vendor 320 refers to one or more local venders that are preferred venders to meet any of the requirements herein, so the nutritional data of a local vendor offering is input into the meal manager 600. Local availability 325 is optionally preferred over a generic vender. Thus, the meal manager 600 is optionally instructed to pay more for a local vender 325, so as to achieve other goals such as sustainability 365. Optionally, the school can opt for a simple menu 330, so as to reduce cost 310, or select a more advanced menu 335, which allows students to learn about nutrition, adds variety 345, provides seasonal variation 355, or fulfills tastes 340 of the student body. Ethical choices 360 are also put in as limits by the school, such as no meat; no pork; and/or nothing or only select items from above a stated distance away, such as less than 50, 100, or 200 miles. Additional ethical choices 360 include: (1) ingredient sourcing, such as selecting foods that are produced in ways that prioritize environmental sustainability, fair labor practices, and/or animal welfare; (2) selecting locally grown or organic produce, sustainably sourced seafood, and/or products that are certified as ethically produced; and/or (3) reducing the environmental impact of food production and distribution, which optionally includes minimizing food waste, which is further described infra, reducing the carbon footprint associated with transportation, and/or supporting practices that conserve natural resources.

### Price

The price 400, for each student, is optionally a regular price 410, a reduced price 420, or is free 430. Generally, The cost of a reduced price meal is lower than the regular price of a school meal but higher than the cost of a free meal. The exact cost varies depending on the school district and location. The federal government provides reimbursements to schools to help cover the cost of providing these meals at a reduced price. The cost of a regular school lunch currently ranges from $2.50 to $4.00 per meal and the maximum price for a reduced-price lunch is currently $0.40.

### Recipes

Recipe databases 500 typically include breakfast recipes 510 and/or lunch recipes 520. The recipes are a key input to the meal manager 600 as the USDA regulations 200 must be met and the recipes drive cost, which is a school preference 200; drive nutrition; and drive vendor selection along with being central in ethical considerations. For clarity of presentation and without loss of generalization, several school lunch recipes ingredients are provided. Naturally, quantities of each ingredient per portion would be provided, but are not provided here for clarity of presentation.

### Example I

### Turkey and Veggie Wraps

### Ingredients:

Whole wheat tortillas
Sliced turkey or chicken
Lettuce or spinach
Sliced tomatoes
Sliced cucumbers.
Shredded carrots
Hummus or low-fat dressing

### Example II

### Veggie Pasta Salad

### Ingredients:

Cooked whole wheat pasta
Cherry tomatoes (halved)
Cucumber (diced)
Bell peppers (diced)
Broccoli florets (blanched)
Black olives (sliced)
Feta cheese (optional)
Italian dressing or vinaigrette

### Example III

### Chicken and Cheese Quesadillas

### Ingredients:

Whole wheat tortillas
Cooked and shredded chicken
Shredded cheese (cheddar, mozzarella, or a mix)
Sliced bell peppers (optional)
Salsa or Greek yogurt (for dipping)

### Example IV

### Veggie and Hummus Platter

### Ingredients:

Baby carrots
Sliced cucumbers
Cherry tomatoes
Sliced bell peppers
Broccoli florets
Snap peas
Hummus for dipping

### Example V

### Tuna Salad Sandwich

### Ingredients:

Canned tuna in water (drained)
Greek yogurt (or mayonnaise)
Diced celery
Diced red onion
Dill pickle relish (optional)
Salt and pepper to taste
Whole grain bread

### Example VI

### Fruit and Yogurt Parfait

### Ingredients:

Greek yogurt
Fresh berries (strawberries, blueberries, raspberries)
Granola
Honey (optional)

The meal manger 600 is further described herein. Generally, the meal manager 600 receives input from each of the USDA regulations 200, school preferences 300, pricing 400, and/or recipe databases 500 modules/inputs and uses the inputs to generate USDA compliant menus 700, preferably while additionally meeting and/or balancing as many of the other inputs as possible. Generally, the meal manager 600 uses an intelligent system 610, a look-up table 620, and/or artificial intelligence 630 to achiever the USDA compliant menus 700. Function of the meal manager 600 is further described, infra.

### Menus

The USDA compliant menus 700 output from the meal manager 600 are further described herein. Generally, the generated menus are daily menus 610, weekly menus 630, monthly menus, and/or semester or yearly menus and typically include breakfast menus 630 and/or lunch menus 630. For clarity of presentation and without loss of generality an example is used to illustrate a school lunch menu.

### Example I

### Weekly School Lunch Menu

Here's a general idea of what a school lunch menu could include:

### Monday:

Grilled chicken sandwich on whole grain bread
Carrot sticks and cucumber slices
Fresh fruit salad (e.g., watermelon, cantaloupe, and grapes)
Low-fat milk or a dairy-free alternative

### Tuesday:

Vegetarian pasta salad with cherry tomatoes, bell peppers, and olives
Orange slices
Whole grain crackers with hummus
Water or water infused with citrus slices

### Wednesday:

Turkey and cheese wrap with whole wheat tortilla
Celery sticks with peanut butter
Low-fat yogurt with granola
Water or low-sugar fruit juice

### Thursday:

Baked fish sticks with a side of brown rice
Steamed broccoli florets
Fresh apple slices
Low-fat milk or a dairy-free alternative

### Friday:

Veggie and cheese quesadillas on whole grain tortillas
Salsa or guacamole for dipping
Mixed fruit cup (e.g., pineapple, peaches, and mandarin oranges)
Water or low-fat milk

Notably, the provided menu example is a general example and may not reflect specific dietary guidelines, regional preferences, or dietary restrictions. Actual school lunch menus may offer more variety and comply with local nutrition standards.

### Meal Manager

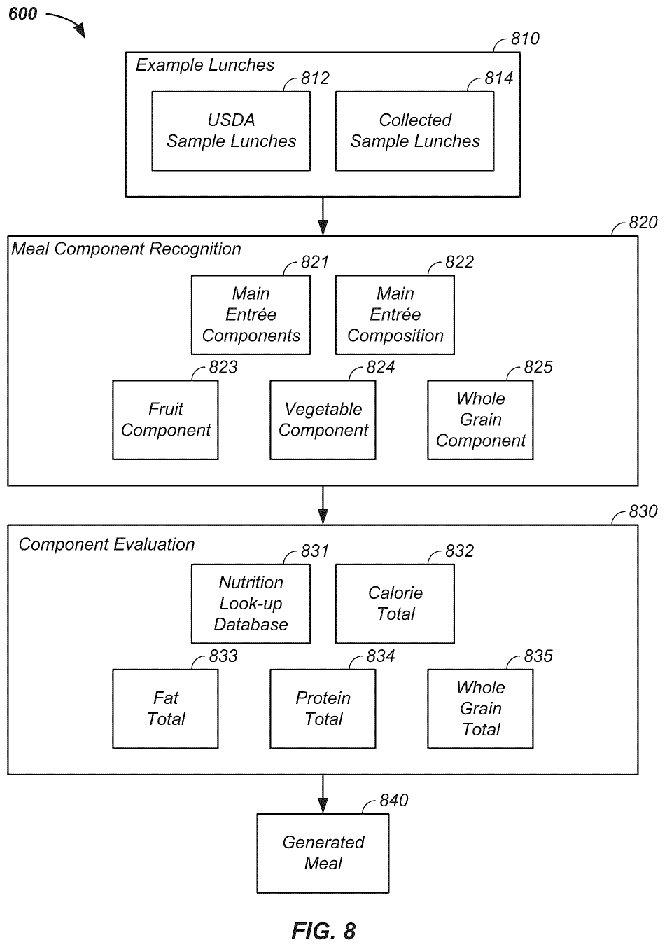

Referring now to FIG. 8, the artificial intelligence system 630 of the meal manager 600 is further described. Generally, the meal manager artificial intelligence system 630 is optionally and preferably trained with example lunches 810, such as the database of USDA sample lunches 812 and/or use of collected sample lunches 814 used in schools nationwide, where the sample lunches are also USDA school lunch approved. The meal manager artificial intelligent system 630 optionally and preferably uses a meal component recognition step/system 820 to determine the main entrée 821 and the main entrée composition 822. For example, a hamburger has a meat component, a bun component, and one or more condiment components. Thus, the main entrée is broken into components. Further, the meal manager artificial intelligent system 630 optionally and preferably recognizes a fruit component 823, a vegetable component 824, a whole grain component 825, and more generally any component required by the USDA school lunch program, such as any component described supra. In a subsequent step, the collection of components are evaluated in a component evaluation step 830. Generally, each component is assessed with a nutrition look-up database or is linked to provided nutrients in the examples. A calorie total 832 is derived/totaled using the portion sizes and the nutrition of each component. Similarly, a fat total 833, protein total 834, and whole grain total 835 are derived/totaled using the portion sizes and the nutrition of each component. Once trained, the meal manager artificial intelligence system 630 provides a generated meal 840 or a set of meals to yield a menu plan for a day, week, month, or longer where the generated meals 840 are USDA compliant as the training set was over a narrow range of meals where the training set meals were at least 80, 90, 95, 96, 97, 98, or 99 percent USDA compliant.

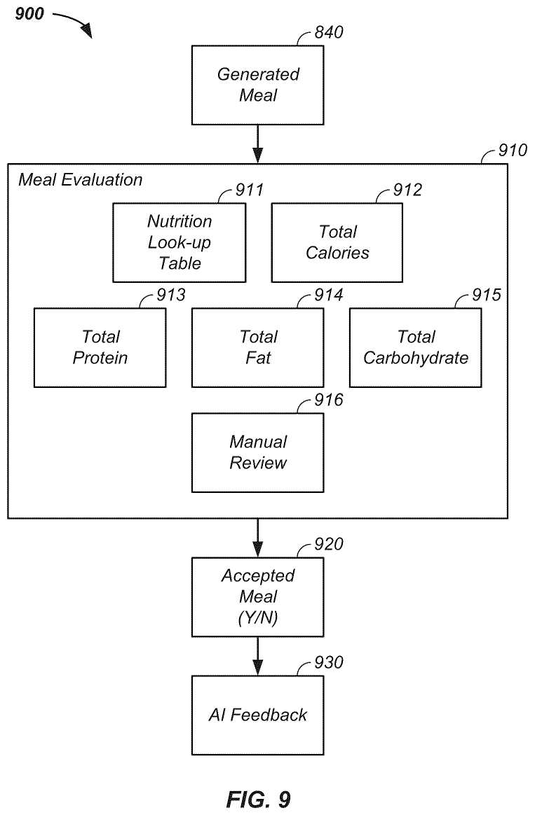

Referring now to FIG. 9, the generated meals 840 are optionally and preferably analyzed with a meal analysis system 900. Generally, an intelligent system and/or a nutritionist algorithm uses a nutrition look-up table 911 and/or the nutrition look-up database 831 to assess the meal in terms of total calories 912, total protein 913, total fat 914, total carbohydrate 915, and/or any metric required by the USDA regulations, as described supra. A manual review 916 is optionally used. The meal evaluation 910 yields an analysis of the meal that is accepted or not 920 in terms of the USDA regulations 200. Optionally and preferably, the results is fed back to the AI system in an AI feedback step 930, such as in a supervised model, described infra.

### Actual Nutrition

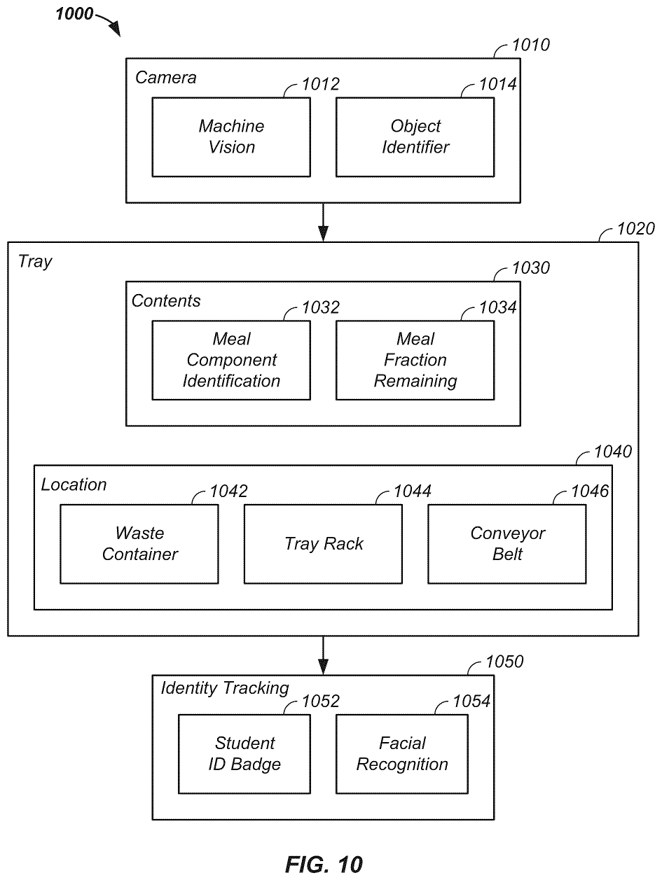

While the USDA regulations 200 are intended to ensure that nutrition is delivered to the student, the USDA regulations 200 do not address what is actually eaten. Referring now to FIG. 10, an actual nutrition intake system analysis 1000 is described. Generally, a camera 1010 is used to analyze what foods and/or what percent of each food was actually eaten by the students. In this manner, future meals may be adjusted that still meat the USDA regulations 200 while also ensuring that selected meals are actually eaten/absorbed by the students.

Still referring to FIG. 10, the actual nutrition intake system analysis 1000 is further described. Generally, the camera 1010 uses machine vision 1012 and an object identifier 1014 to determine what remains on a tray at time of disposal. For example, the machine vision 1012 and object identifier 1014 looks at a tray 1020 to determine contents 1030 of the tray, such as a meal component identification 1032 and/or a meal fraction remaining 1034. For instance, the meal component identification 1032 recognizes green beans and then recognizes if all of the green beans remain or what percentage of the green beans remain, such as 0-25, 25-50, 50-75, or 75-100%. The process is optionally and preferably repeated for each meal component, such as a burger, fries, salad, and/or fruit cup. The nutrition look-up database 831 is then used to assess the remaining meal components in terms of total calories 912, total protein 913, total fat 914, total carbohydrate 915, and/or any metric required by the USDA regulations, as described supra, and the totals are subtracted from the provided meal nutrition elements to determine what nutrition was actually consumed by the students.

Still referring to FIG. 10, the camera(s) 1010 analyzing the tray 1020 is optionally positioned at a tray collection point, location 1040, and/or a tray component disposal point, such as at a waste container 1042, tray rack 1044, and/or a conveyor belt 1046 for collecting trays.

Still referring to FIG. 10, the camera 1010 is optionally used for identity tracking 1050, such as by recognizing particular individuals, such as through use of a student ID badge 1052 and/or via facial recognition 1054. In this manner, nutrition of individual students is optionally tracked. This is particularly useful for tracking athletes, those with allergies, and/or economically disadvantaged students.

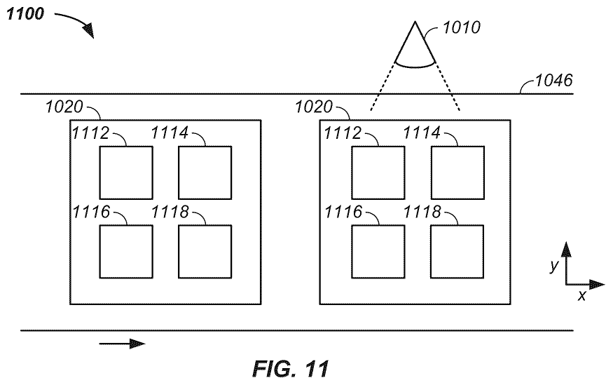

Referring now to FIG. 11, a tray analysis system 1100 is illustrated. Generally, the tray 1020 is analyzed on a conveyor belt 1046 with the camera 1010. In this example, the tray has four meal components, a first meal component 1112, a second meal component 1114, a third meal component 1116, and a fourth meal component 1118 of n meal components, where n is a positive integer of greater than 1, 2, 3, 4, or 5. Each of the meal components are recognized with the machine vision 1012 and object identifier 1014 as described supra. Further, each meal component is identified 1032 and assessed in term so meal component fraction remaining 1034, as described supra. Then, the meal is assessed in terms of actual nutrition eaten by the student, as described supra.

### AI Training

AI, or Artificial Intelligence, refers to the simulation of human intelligence processes by computer systems. In other words, AI enables machines to perform tasks that typically require human intelligence, such as understanding natural language, recognizing patterns, solving complex problems, and learning from experience.

Herein, the AI system is optionally classified as narrow or weak AI, where the AI is designed and trained for a specific task or a narrow set of tasks, such as recognizing meal components and fractions thereof.

Generally, the AI system 630 of the meal manager 600 is trained with any supervised or unsupervised machine learning algorithm. Algorithms used by the AI system and/or with a pattern recognition system depend on the type of label output, on whether learning is supervised or unsupervised, and/or on whether the algorithm is statistical or non-statistical in nature. Statistical algorithms are herein further classified as generative or discriminative. Several non-limiting examples of algorithms/tools used in the matching system 210 include, but are not limited to:
a classification algorithm;
a supervised algorithms predicting a categorical label;
a decision tree;
a decision list;
a Bayesian classifier;
a neural network;
a clustering algorithm;
a multivariate model;
a Kalman filter;
a particle filter;
an expert system;
a hierarchical system; and/or
a hierarchical mixture of experts.

AI systems optionally utilize various techniques and technologies to achieve their objectives, including:
Machine learning, which training algorithms to learn from data and improve their performance over time. Examples of machine learning techniques include supervised learning, unsupervised learning, and reinforcement learning;
Neural networks, which are a fundamental component of many AI systems, inspired by the structure of the human brain. They consist of interconnected nodes (neurons) organized in layers that process and transform data;
Computer vision, which allows computers to interpret and understand visual information from the world, enabling tasks such as image and video analysis, object recognition, and facial recognition; and
Expert systems, which are designed to replicate the decision-making abilities of a human expert in a specific domain, often using rules and knowledge-based approaches.

In one example, a method for planning meals, comprises the steps of: (1) creating a menu with a meal manager system, the meal manager system comprising a computerized intelligent system; (2) analyzing the menu with a meal analysis system, the step of analyzing further comprising the steps of: (a) breaking the menu into meal components; (b) computing, with a nutrition look-up database, nutritional components, the nutritional components comprising at least a total protein, a total fat, and a total carbohydrate of the meal components; and (c) confirming accordance of the nutritional components with requirements of a United States Department of Agriculture school meal program; and (3) distributing, after the step of confirming, the menu to at least one school district.

Still yet another embodiment includes any combination and/or permutation of any of the elements described herein.

Herein, any number, such as 1, 2, 3, 4, 5, is optionally more than the number, less than the number, or within 1, 2, 5, 10, 20, or 50 percent of the number.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

In the foregoing description, the invention has been described with reference to specific exemplary embodiments; however, it will be appreciated that various modifications and changes may be made without departing from the scope of the present invention as set forth herein. The description and figures are to be regarded in an illustrative manner, rather than a restrictive one and all such modifications are intended to be included within the scope of the present invention. Accordingly, the scope of the invention should be determined by the generic embodiments described herein and their legal equivalents rather than by merely the specific examples described above. For example, the steps recited in any method or process embodiment may be executed in any order and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

Although the invention has been described herein with reference to certain preferred embodiments, one skilled in the art will readily appreciate that other applications may be substituted for those set forth herein without departing from the spirit and scope of the present invention. Accordingly, the invention should only be limited by the Claims included below.

1. A method for planning meals, comprising the steps of:
creating a menu with a meal manager system, said meal manager system comprising a computerized intelligent system;
analyzing said menu with a meal analysis system, said step of analyzing further comprising the steps of:
breaking said menu into meal components;
computing, with a nutrition look-up database, nutritional components, said nutritional components comprising at least a total protein, a total fat, and a total carbohydrate of said meal components; and
confirming accordance of said nutritional components with requirements of a United States Department of Agriculture school meal program; and
distributing, after said step of confirming, said menu to at least one school district.

2. The method of claim 1, said step of creating further comprising the step of:
using in said intelligent system an artificial intelligence system.

3. The method of claim 2, further comprising the step of:
training, previous to said step of creating, said artificial intelligence system with a recipe database.

4. The method of claim 2, further comprising the step of:
training, previous to said step of creating, said artificial intelligence system with National School Lunch Program approved lunches.

5. The method of claim 4, said step of training further comprising the step of:
recognizing, with said computerized intelligent system, a main entrée, a side dish, and a dessert of at least one lunch of said approved lunches;
breaking said main entrée, said side dish, and said dessert into lunch components comprising at least a protein component, a fat component, and a carbohydrate component.

6. The method of claim 1, said step of creating further comprising the steps of:
formulating lunches, in accordance with National School Lunch Program guidelines of the United States Department of Agriculture, with at least five components of: protein foods, milk, grains, fruits, and vegetables.

7. The method of claim 6, said step of creating further comprising the steps of:
formulating breakfasts with at least four components in accordance with School Breakfast Program guidelines of the United States Department of Agriculture.

8. The method of claim 7, said step of creating further comprising the step of:
altering said menu, in terms of calories and said total protein, as a function of grade level.

9. The method of claim 7, further comprising the step of:
informing said at least one school district of a nutritional make-up of said menu, said nutritional make-up comprising at least total calories as a function of grade level.

10. The method of claim 6, further comprising the step of:
conforming said menu, provided by said computerized intelligent system, with a pricing requirement of said at least one school district.

11. The method of claim 10, further comprising the step of:
conforming said menu, provided by said computerized intelligent system, with an ethical consideration of said at least one school district.

12. The method of claim 11, further comprising the step of:
conforming said menu, provided by said computerized intelligent system, with a local vendor requirement of said at least one school district.

13. The method of claim 1, further comprising the step of:
implementing a vision system to establish a statistical evaluation of remaining food items on student trays after a meal period.

14. The method of claim 13, further comprising the step of:
feeding back said statistical evaluation to said intelligent system in a training step of said intelligent system.
